(19) United States
(12) Patent Application Publication
(10) Pub. No.: US 2018/0078014 A1
(43) Pub. Date: Mar. 22, 2018

(54) Case having gripping hole for tablet/mobile phone

(71) Applicants: Davy Zide Qian, Arcacia, CA (US); Benyu Qian, Shanghai (CN); Lequn Lu, Shanghai (CN)

(72) Inventors: Davy Zide Qian, Arcacia, CA (US); Benyu Qian, Shanghai (CN); Lequn Lu, Shanghai (CN)

(21) Appl. No.: 15/478,242

(22) Filed: Apr. 3, 2017

Related U.S. Application Data
(60) Provisional application No. 62/317,584, filed on Apr. 3, 2016.

(51) Int. Cl. A45C 13/26; A45C 11/00; G06F 1/16

(52) U.S. Cl. CPC A45C 13/26; A45C 11/00; A45C 2013/025; G06F 1/1626; G06F 1/1628

(57) ABSTRACT

A case having gripping hole for tablet/mobile phone comprises a base plate for placing a tablet/mobile phone thereon; a releasable holding means for the tablet/mobile phone, the releasable holding means is fixed on the base plate; a cover plate for covering the tablet/mobile phone, a plurality of gripping hole arrayed in a line are on the cover plate and parallel to a long side of the cover plate, the gripping hole can be a rectangular hole; and an elastic connecting strip connects the base plate with the cover plate together. People can easy hold the case with tablet/mobile phone by using the gripping holes.

### CROSS REFERENCE TO RELATED PATENT APPLICATION

The present application claims the priority of U.S. 62/317,584 filed Apr. 3, 2016, which application is incorporated herein by reference.

### FIELD OF THE INVENTION

A case having gripping hole for tablet/mobile phone, which belongs to the accessories of tablets and mobile phones.

### BACKGROUND OF THE INVENTION

Now, the scale of tablets and mobile phones grew and grew. While the big screen is easier to read, but the habit of using the hand holding the mobile phone or tablet and using thumb to operate the touch-screen becomes increasingly difficult, sometimes even causes mobile phone or tablet falling to the ground to be damaged. Various existing mobile phone or tablet cases, they just have functions of protection or supporting the phone or tablet on the table, but cannot solve the above mentioned difficulty.

The purpose of the present invention is to provide a case having gripping hole for tablet/mobile phone for solve the above mentioned difficulty, i.e. the new case having gripping hole for tablet/mobile phone can help people using his fingers and palm to hold phone or tablet easily and using the other hand for operating the touch-screen safely.

### SUMMARY OF THE INVENTION

The purpose of present invention is realized by the following conceptions:

A case having gripping hole for tablet/mobile phone comprises a base plate for placing a tablet/mobile phone thereon; a releasable holding means for the tablet/mobile phone, the releasable holding means is fixed on the base plate; a cover plate for covering the tablet/mobile phone, a plurality of gripping holes arrayed in a line are on the cover plate and parallel to a long side of the cover plate and an elastic connecting strip connecting the base plate with the cover plate together.

The base plate and the cover plate are rectangular plate respectively.

The plurality of gripping holes are one gripping hole, which is a rectangular hole, a long side of the rectangular hole is parallel to a long side of the cover plate.

The plurality of gripping holes are four or eight gripping holes.

User uses fingers inserting in the gripping holes to coordinate with the rest fingers to form a secure grip of the case and tablet/mobile phone combination, while the fingers of other hand can operate the tablet/mobile phone.

### BRIEF DESCRIPTION OF THE DRAWINGS

FIG. 1 is front view of the case having gripping hole for tablet/mobile phone of the present invention, the case has a rectangular hole in a cover plate of the case.

FIG. 2 is the case shown in the FIG. 1, a tablet/mobile phone is held on a base plate of the case.

FIG. 3 is the case shown in the FIG. 1, the cover plate turns to cover the tablet/mobile phone.

FIG. 4 is the case has a plurality of gripping holes arrayed in a line, which are in the cover plate.

FIGS. 5 and 6 show the usage of the case having gripping hole for tablet/mobile phone.

### DETAIL DESCRIPTION OF THE INVENTION

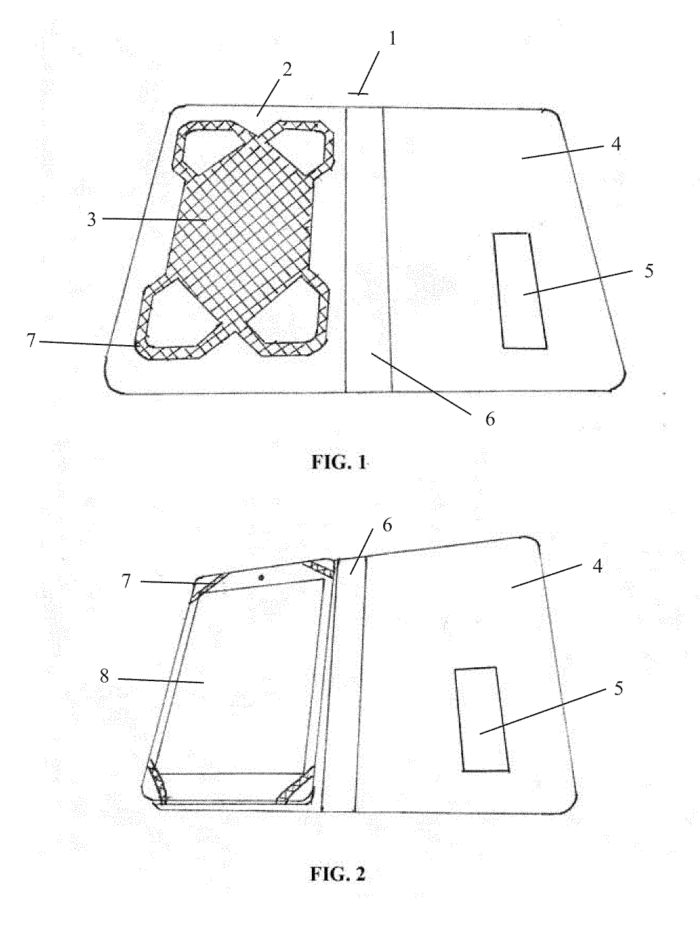

As shown in FIGS. 1 and 2, the case having gripping hole for tablet/mobile phone 1 is composed by a base plate 2 for placing a tablet/mobile phone thereon; a releasable holding means 3 for the tablet/mobile phone 8, the releasable holding means 3 is fixed on the base plate 2; a cover plate 4 for covering the tablet/mobile phone 8, a rectangular gripping hole 5 is in the cover plate 4 and parallel to a long side of the cover plate 4; an elastic connecting strip 6 connects the base plate 2 with the cover plate 4 together.

The base plate 2 and the cover plate 4 are rectangular plate respectively.

As shown in FIG. 2, the releasable holding means 3 has four elastic rings 7 corresponding to four corners of the tablet/mobile phone 8 respectively, each elastic ring 7 hold one corner of the tablet/mobile phone 8, therefore the tablet/mobile phone 8 is held on the base plate 2.

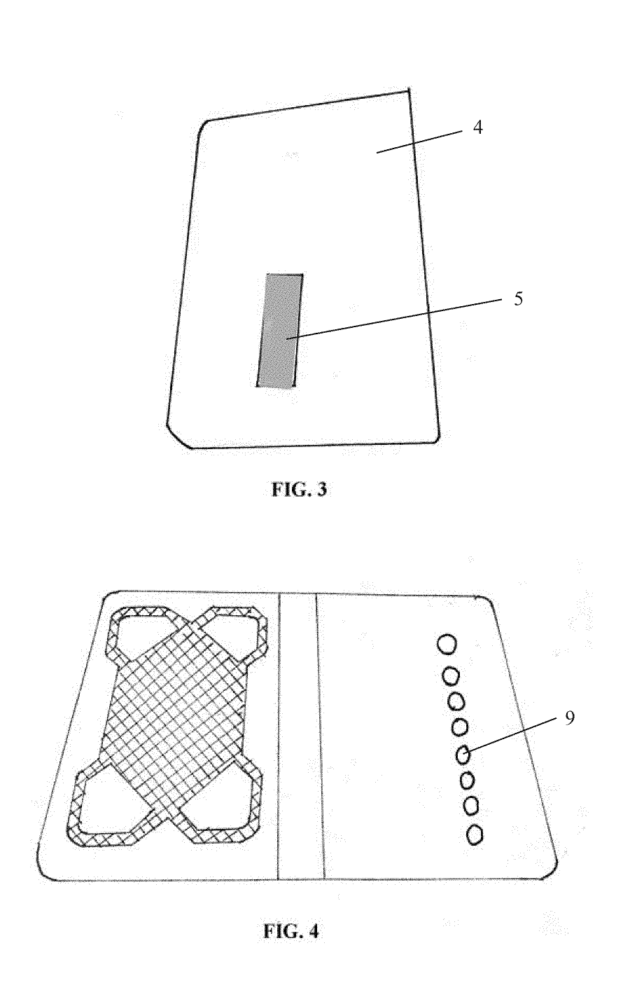

As shown in FIG. 3, the cover plate 4 is turned to cover the tablet/mobile phone 8 for protection.

As shown in FIG. 4, a plurality of gripping holes 9 arrayed in a line are on the cover plate 4 and parallel to a long side of the cover plate 4. There are four gripping holes, user can use four fingers to hold the case with tablet/mobile phone. In other embodiment, there are eight gripping holes, user can use the higher gripping holes or lower gripping holes to hold the case with tablet/mobile phone, that brings a convenience.

As shown in FIGS. 1 and 2 the releasable holding means 3 has four elastic rings 7 corresponding to four corners of the tablet/mobile phone respectively, each elastic ring hold one corner of the tablet/mobile phone, thereby the tablet/mobile phone is held on the base plate. The body part of releasable holding means 3 is fixed on the base plate 2.

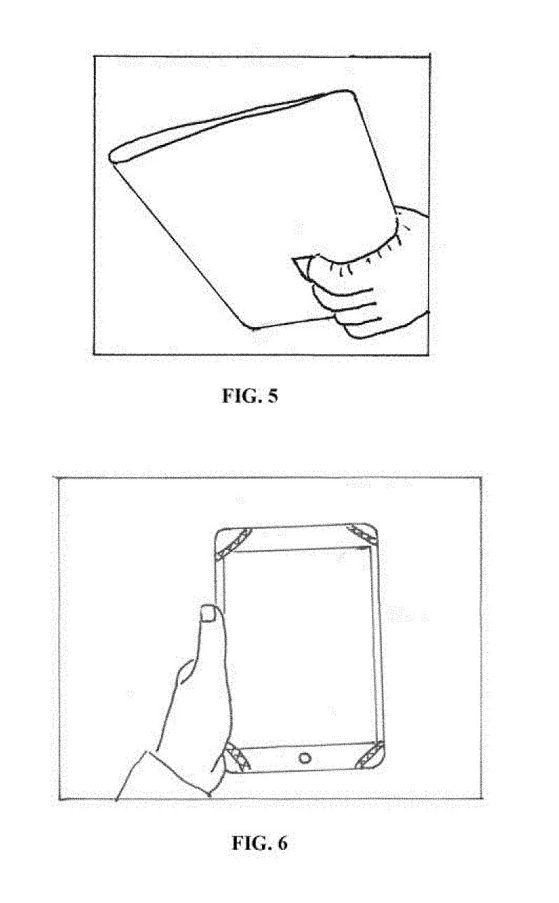

As shown in FIGS. 5 and 6, people can easy hold the case with tablet/mobile phone by using the gripping holes.

What is claimed is:

1. A case having gripping hole for tablet/mobile phone comprising:
a base plate for placing a tablet/mobile phone thereon;
a releasable holding means for the tablet/mobile phone, the releasable holding means is fixed on the base plate;
a cover plate for covering the tablet/mobile phone, a plurality of gripping holes arrayed in a line are on the cover plate and parallel to a long side of the cover plate;
an elastic connecting strip connecting the base plate with the cover plate together.

2. The case having gripping hole for tablet/mobile phone of claim 1, wherein the base plate and the cover plate are a rectangular plate respectively.

3. The case having gripping hole for tablet/mobile phone of claim 1, wherein the plurality of gripping holes are one gripping hole, which is a rectangular hole, a long side of the rectangular hole is parallel to a long side of the cover plate.

4. The case having gripping hole for tablet/mobile phone of claim 1, wherein the plurality of gripping holes are 4 gripping holes.

5. The case having gripping hole for tablet/mobile phone of claim 1, wherein the plurality of gripping holes are 8 gripping holes.

6. The case having gripping hole for tablet/mobile phone of claim 1, wherein the releasable holding means has four elastic rings corresponding to four corners respectively, each elastic ring hold one corner of the tablet/mobile phone, thereby the tablet/mobile phone is held on the base plate.
